(19) United States
(12) Patent Application Publication
(10) Pub. No.: US 2017/0370378 A1
(43) Pub. Date: Dec. 28, 2017

(54) COMPRESSOR AND SUPERCHARGING SYSTEM OF INTERNAL COMBUSTION ENGINE

(71) Applicant: Honda Motor Co.,Ltd., Tokyo (JP)

(72) Inventors: Naoki KUNO, Saitama (JP); Naoki ITOH, Saitama (JP)

(73) Assignee: Honda Motor Co.,Ltd., Tokyo (JP)

(21) Appl. No.: 15/618,136

(22) Filed: Jun. 9, 2017

(30) Foreign Application Priority Data
Jun. 28, 2016 (JP) 2016-127492

(51) Int. Cl. F04D 29/42; F02B 37/00

(52) U.S. Cl. CPC F04D 29/4226; F02B 37/00; F04D 29/4213

(57) ABSTRACT

A compressor capable of generating a swirling flow at a sufficient speed with respect to a main flow of intake air that flows into a compressor impeller without hindering the main flow. The compressor includes a compressor impeller, a shroud covering a tip end edge of the impeller, an intake duct extending along an axial direction of the impeller, a swirling flow passage being annular around a rotating shaft and having a flow passage cross-sectional area that gradually decreases along the same direction as a rotation direction of the impeller from a base end side where a swirling gas introduction portion is disposed toward a front end side, and a swirling gas ejection passage extending along a radial direction of the impeller. The swirling gas introduction portion is connected to a portion on a downstream side of the front edge portion of the impeller in the intake flow passage.

### CROSS-REFERENCE TO RELATED APPLICATION

This application claims the priority benefit of Japan application serial no. 2016-127492, filed on Jun. 28, 2016. The entirety of the above-mentioned patent application is hereby incorporated by reference herein and made a part of this specification.

### BACKGROUND OF THE INVENTION

### Field of the Invention

The invention relates to a compressor and a supercharging system of an internal combustion engine equipped with the compressor.

### Description of Related Art

The compressor of a supercharger includes a compressor housing, which constitutes a part of an intake flow passage of an internal combustion engine, and a compressor impeller disposed rotatably in the compressor housing. The compressor impeller is connected to a turbine impeller, which is disposed rotatably in a turbine housing that constitutes a part of an exhaust flow passage of the internal combustion engine, through a rotating shaft. When the turbine impeller rotates due to the energy of an exhaust air, the compressor impeller rotates as well, and the intake air is discharged toward an annular scroll passage formed around the compressor impeller, so as to be boosted.

Patent Literature 1 has disclosed a technique of creating a swirling flow in the same direction as the rotation direction of the compressor impeller with respect to the intake air that flows into the compressor impeller. According to the technique of Patent Literature 1, the swirling flow with respect to the intake air that flows into the inlet of the compressor impeller via a main intake flow passage is created through formation of a swirling intake flow passage that goes over the entire circumference around the main intake flow passage leading to the inlet of the compressor impeller. The range of the intake flow rate (also referred to as “flow rate range” hereinafter) that the compressor can supercharge has a lower limit. If it drops below the lower limit, a stall may occur, but it is considered possible to lower the lower limit by creating such a swirling flow.

According to the technique of Patent Literature 1, a branch intake flow passage that branches from the main intake flow passage to the swirling intake flow passage is disposed to introduce a part of the main flow flowing through the main intake flow passage to the swirling intake flow passage, so as to create the swirling flow described above. In addition, according to the technique of Patent Literature 1, an intake flow passage regulating valve is disposed in the portion where the main intake flow passage and the branch intake flow passage branch off, and an inclination angle of the intake flow passage regulating valve with respect to the main flow is varied in a range of 0° to 90°, so as to adjust the amount of the intake air introduced from the main flow into the branch intake flow passage, i.e., the speed of the swirling flow.

### PRIOR ART LITERATURE

### Patent Literature

Patent Literature 1: Japanese Patent Publication No. 2011-111988

### SUMMARY OF THE INVENTION

### Problem to be Solved

In the technique of Patent Literature 1 as described above, the swirling flow is generated by introducing a part of the main flow of the intake air that flows into the turbine impeller into the branch intake flow passage. Therefore, the generated swirling flow may not reach a sufficient speed. Moreover, since the technique of Patent Literature 1 disposes the intake flow passage regulating valve in the main intake flow passage to introduce a part of the main flow into the branch intake flow passage, it enhances the pressure drop in the intake flow passage and raises the concern that a sufficient amount of air may not be supplied to the internal combustion engine.

The invention provides a compressor and a supercharging system of an internal combustion engine including the compressor, wherein the compressor is capable of generating a swirling flow at a sufficient speed with respect to a main flow of a fluid that flows into a compressor impeller without hindering the main flow.

### Solution to the Problem

(1) A compressor (for example, the compressors 6 and 6′ which will be described later) is for compressing a fluid that flows through a fluid flow passage. The compressor includes: an impeller (for example, the compressor impeller 8 which will be described later) being rotatable around a rotating shaft (for example, the rotating shaft 21 which will be described later); a shroud (for example, the shroud 721 which will be described later) covering a side portion (for example, the tip end edge 843 which will be described later) of the impeller and constituting a part of the fluid flow passage; a fluid duct (for example, the intake duct 73 which will be described later) being tubular and extending along an axial direction of the impeller and introducing the fluid to a front edge (for example, the front edge portion 841 which will be described later) of the impeller; a scroll flow passage (for example, the scroll flow passage 773 which will be described later) being annular around the rotating shaft, wherein a flow passage cross-sectional area of the scroll flow passage gradually decreases along a circumferential direction of the impeller from a base end side (for example, the side of the base end portion 771 which will be described later) where a fluid introduction portion (for example, the swirling gas introduction portion 774 which will be described later) is disposed toward a distal end side (for example, the side of the distal end portion 772 which will be described later); and a fluid ejection passage (the swirling gas ejection passage 78 which will be described later) extending along a radial direction of the impeller and connecting an inside of the scroll flow passage and an inside of the fluid duct. The fluid introduction portion is connected to a portion on a downstream side of the front edge of the impeller in the fluid flow passage.

(2) In this case, preferably an angle formed by an extending direction of the fluid ejection passage and an inner peripheral surface in the fluid duct is an acute angle.

(3) In this case, preferably the flow passage cross-sectional area of the scroll flow passage gradually decreases along a direction the same as a rotation direction of the impeller from the base end side toward the distal end side.

(4) In this case, preferably the flow passage cross-sectional area of the scroll flow passage gradually decreases along a direction opposite to a rotation direction of the impeller from the base end side toward the distal end side.

(5) In this case, preferably the compressor further includes a compressor housing (for example, the compressor housing 7 which will be described later) formed with the fluid duct, the shroud, the scroll flow passage, and a high pressure flow passage (for example, the diffuser chamber 74 and the main scroll flow passage 75 which will be described later), which is a part of the fluid flow passage and through which a fluid discharged from a rear edge (for example, the rear edge portion 842 which will be described later) of the impeller flows. The fluid introduction portion is connected to the shroud or the high pressure flow passage in the compressor housing.

(6) In this case, preferably the fluid introduction portion is connected to the shroud.

(7) In this case, preferably a diffuser chamber (for example, the diffuser chamber 74 which will be described later) is disposed in the compressor housing and the diffuser chamber is a part of the high pressure flow passage and decelerates the fluid discharged from the rear edge of the impeller in the radial direction, and the fluid introduction portion is connected to the diffuser chamber.

(8) In this case, preferably a main scroll flow passage (for example, the main scroll flow passage 75 which will be described later) that is annular around the rotating shaft is disposed in the compressor housing and the main scroll flow passage is a part of the high pressure flow passage and the fluid discharged from the rear edge of the impeller in the radial direction flows through the main scroll flow passage, and the fluid introduction portion is connected to the main scroll flow passage.

(9) A supercharging system (for example, the supercharging system S which will be described later) of an internal combustion engine includes: a compressor (for example, the compressor 6′ which will be described later) disposed in an intake flow passage (for example, the intake flow passage 92 which will be described later) of the internal combustion engine (for example, the internal combustion engine 91 which will be described later); a turbine (for example, the turbine 3 which will be described later) disposed in an exhaust flow passage (for example, the exhaust flow passage 93 which will be described later) of the internal combustion engine; and a rotating shaft (for example, the rotating shaft 21 which will be described later) connecting an impeller (for example, the compressor impeller 8 which will be described later) of the compressor and an impeller (for example, the turbine impeller 5 which will be described later) of the turbine. The compressor described in (1) or (2) is used as the compressor, and the fluid introduction portion is connected to an upstream side of the impeller of the turbine in the exhaust flow passage.

### Effects of the Invention

(1) According to the invention, the tubular fluid duct that extends along the axial direction of the impeller and introduces the main flow of the fluid to the front edge of the impeller, the scroll flow passage which is annular around the rotating shaft and has the flow passage cross-sectional area that gradually decreases along the circumferential direction of the impeller from the base end side where the fluid introduction portion is disposed toward the distal end side, and the fluid ejection passage which extends along the radial direction of the impeller and connects the inside of the scroll flow passage and the fluid duct through which the main flow flows are disposed. Thus, the fluid introduced from the fluid introduction portion to the scroll flow passage is accelerated along the circumferential direction while flowing through the scroll flow passage, and is ejected into the fluid duct via the fluid ejection passage, so that a swirling flow is created along the circumferential direction with respect to the main flow that flows through the fluid duct. Thus, the fluid easily flows to the front edge of the impeller, so that the lower limit of the flow rate range of the compressor can be lowered. Moreover, according to the invention, the fluid introduction portion, which is the inlet of the scroll flow passage, is connected to the portion on the downstream side of the front edge of the impeller in the fluid flow passage. Here, the portion on the downstream side of the front edge of the impeller in the fluid flow passage has a total pressure, which is a combination of a static pressure and a dynamic pressure, higher than that inside the fluid duct. Accordingly, the invention generates the swirling flow by using the fluid recirculated due to such differential pressure. Thus, according to the invention, the swirling flow can be generated without using a part of the main flow that flows through the fluid duct. Therefore, the generated swirling flow has a sufficient speed as compared with the conventional art. Furthermore, according to the invention, since the swirling flow is generated by recirculating the fluid, there is no need to dispose a device hindering the main flow in the fluid duct. Thus, the pressure drop in the fluid duct is not worsened.

(2) According to the invention, the angle formed by the extending direction of the fluid ejection passage, which connects the inside of the scroll flow passage and the inside of the fluid duct, and the inner peripheral surface of the fluid duct is set to an acute angle, by which a swirling flow having an axial velocity component can be ejected from the fluid ejection passage. Thus, the lower limit of the flow rate range can be further lowered.

(3) According to the invention, the flow passage cross-sectional area of the scroll flow passage is gradually decreased along the same direction as the rotation direction of the impeller. Thus, the fluid introduced from the fluid introduction portion to the scroll flow passage is accelerated in the same direction as the rotation direction of the impeller in the process of flowing from the base end side toward the distal end side, and is ejected into the fluid duct via the fluid ejection passage, so as to create a swirling flow in the same direction as the rotation direction of the impeller with respect to the main flow that flows through the fluid duct. When such a swirling flow is created in the fluid flowing to the front edge of the impeller, as will be described later with reference to FIG. 6 and FIG. 7, the relative inflow angle of the fluid on the radial outer side of the impeller decreases and the fluid flows easily to the front edge of the impeller. Thus, the lower limit of the flow rate range of the compressor can be further lowered.

(4) According to the invention, the flow passage cross-sectional area of the scroll flow passage is gradually decreased along the direction opposite to the rotation direction of the impeller. Thus, the fluid introduced from the fluid introduction portion to the scroll flow passage is accelerated in the direction opposite to the rotation direction of the impeller in the process of flowing from the base end side toward the distal end side, and is ejected into the fluid duct via the fluid ejection passage, so as to create a swirling flow in the direction opposite to the rotation direction of the impeller with respect to the main flow that flows through the fluid duct. Here, in a state close to a stall, that is, when the flow rate of the fluid is close to the lower limit, the main flow in the fluid duct in the vicinity of the shroud on the radial outer side of the impeller tends to follow the rotation direction of the impeller. On the other hand, the invention creates the swirling flow in the direction opposite to the rotation direction of the impeller to reduce the following. Therefore, the lower limit of the flow rate range of the compressor can be further lowered. However, in the case where the direction of the scroll flow passage is set opposite to the rotation direction of the impeller as in the invention, in order to reduce only the following and not to cause great influence on the entire main flow flowing through the fluid duct, the flow rate of the fluid ejected from the fluid ejection passage into the fluid duct is preferably set to about 10% or less of the flow rate of the entire fluid that flows into the impeller.

(5) According to the invention, the compressor housing is formed with the fluid duct, the shroud, the scroll flow passage, and the high pressure flow passage, and the fluid introduction portion of the scroll flow passage is connected to the shroud or the high pressure flow passage. Since the fluid can be recirculated in the compressor housing, the size of the entire compressor can be reduced. That is, in a case where a fluid supply source connected to the fluid introduction portion is disposed outside the compressor housing, it is necessary to dispose piping independent of the compressor housing. According to the invention, however, such piping is not required. Moreover, in the fluid flow passage, the shroud and the high pressure flow passage are in the vicinity of the impeller, and the total pressure is higher than the other portions. Accordingly, by recirculating the fluid from such portions, a fast swirling flow can be generated.

(6) According to the invention, a fast swirling flow can be generated by connecting the fluid introduction portion and the shroud. In addition, because the shroud, the fluid duct, and the scroll flow passage are disposed at positions close to one another, according to the invention, the flow passage connecting the fluid introduction portion and the shroud can be shortened. Thus, the pressure drop in the flow passage can be suppressed.

(7) According to the invention, a fast swirling flow can be generated by connecting the fluid introduction portion and the diffuser chamber. In addition, because the diffuser chamber, the fluid duct, and the scroll flow passage are disposed at positions close to one another, according to the invention, the flow passage connecting the fluid introduction portion and the diffuser chamber can be shortened. Thus, the pressure drop in the flow passage can be suppressed.

(8) According to the invention, a fast swirling flow can be generated by connecting the fluid introduction portion and the main scroll flow passage.

(9) In the supercharging system of the internal combustion engine of the invention, the fluid introduction portion, which is the inlet of the scroll flow passage, is on the downstream side of the front edge of the impeller in the fluid flow passage, and is further connected to the upstream side of the turbine impeller in the exhaust flow passage. That is, according to the invention, the so-called high pressure external EGR gas is supplied to the fluid introduction portion to generate a swirling flow. Thus, in addition to the effect of generating a high-speed swirling flow, it is also possible to achieve effects, such as reduction of NOx in the exhaust air and improvement of fuel efficiency, that are expected by recirculating a part of the exhaust air to the intake air.

### BRIEF DESCRIPTION OF THE DRAWINGS

FIG. 1 is a cross-sectional view showing the configuration of a supercharger that uses a compressor according to the first embodiment of the invention.

FIG. 2 is a perspective view of a compressor impeller.

FIG. 3 is a cross-sectional view of a compressor housing taken along the line III-III.

FIG. 4 is a perspective cross-sectional view of the compressor housing taken along a plane including the axis.

FIG. 5 is a cross-sectional view of the compressor housing, which schematically shows a position for disposing a gas acquisition port.

FIG. 6 is a diagram schematically showing a variation of a velocity triangle at a front edge portion of a compressor impeller when a swirling flow is generated in an axial flow passage by an axial flow swirler.

FIG. 7 is a diagram showing a radial distribution of a relative inflow angle at the front edge portion of the compressor impeller.

FIG. 8 is a diagram showing the configuration of a supercharging system of an internal combustion engine according to the second embodiment of the invention.

### DESCRIPTION OF THE EMBODIMENTS

### First Embodiment

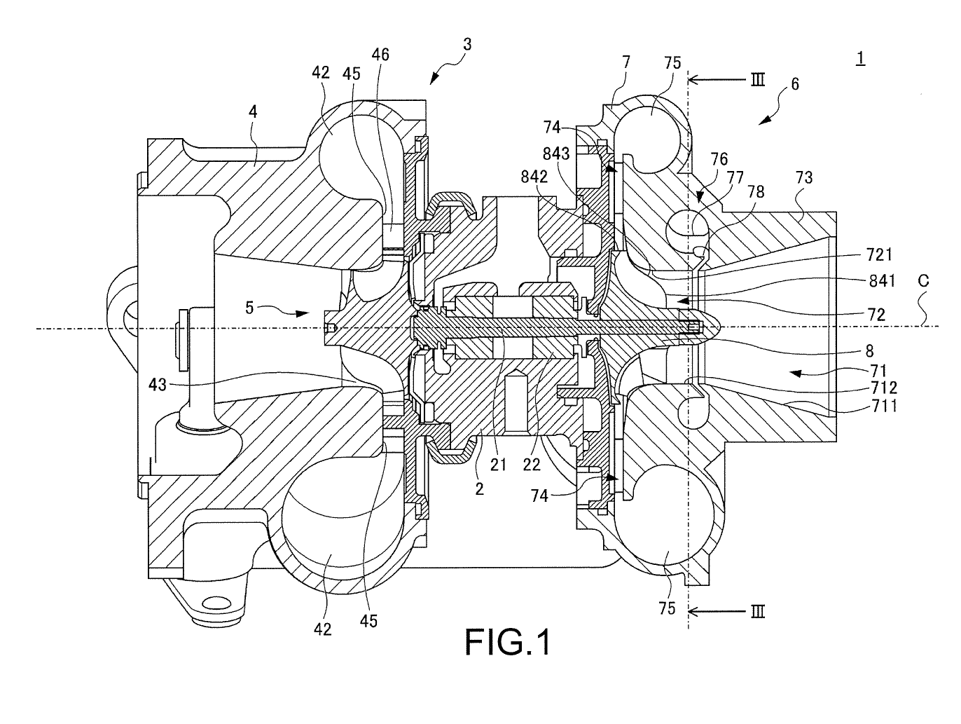

The first embodiment of the invention is described hereinafter with reference to the figures. FIG. 1 is a cross-sectional view showing the configuration of a supercharger 1 that uses a compressor according to the present embodiment.

The supercharger 1 includes a bearing housing 2, a turbine 3 assembled to one end side of the bearing housing 2, and a compressor 6 assembled to the other end side of the bearing housing 2. The bearing housing 2 includes a rod-shaped rotating shaft 21 and a bearing 22. The rotating shaft 21 extends between the turbine 3 and the compressor 6. The bearing 22 rotatably supports the rotating shaft 21.

The turbine 3 includes a turbine housing 4 and a turbine impeller 5. The turbine housing 4 constitutes a part of an exhaust flow passage through which an exhaust air of an internal combustion engine (not shown) flows, and the turbine impeller 5 is disposed in the turbine housing 4. The turbine 3 converts energy of the exhaust air that flows through the exhaust flow passage into mechanical power.

An exhaust introduction duct (not shown) connected to the exhaust flow passage of the internal combustion engine, an annular turbine scroll flow passage 42 through which the exhaust air introduced from the exhaust introduction duct flows, a tubular turbine impeller chamber 43 formed to be surrounded by the turbine scroll flow passage 42, and an annular exhaust flow passage 45 communicating the turbine scroll flow passage 42 with a base end side of the turbine impeller chamber 43 are disposed in the turbine housing 4.

The turbine impeller 5 is disposed to be rotatable in the turbine impeller chamber 43 in a state of being connected to the one end side of the rotating shaft 21. In the exhaust flow passage 45, a plurality of blade-shaped nozzle vanes 46 are arranged at equal intervals along a circumferential direction of the rotating shaft 21 at a predetermined angle with respect to the circumferential direction, so as to surround the base end side of the turbine impeller chamber 43.

The exhaust air of the internal combustion engine introduced into the turbine scroll flow passage 42 via the exhaust introduction duct is accelerated in the circumferential direction as it flows through the turbine scroll flow passage 42, and flows inward in a radial direction of the rotating shaft 21 to the base end side of the turbine impeller 5 via the exhaust flow passage 45. The turbine impeller 5 is rotated by the energy of the exhaust air introduced as described above.

The compressor 6 includes a compressor housing 7 and a disk-shaped compressor impeller 8. The compressor housing 7 constitutes a part of an intake flow passage of the internal combustion engine. The compressor impeller 8 is disposed to be rotatable around the rotating shaft 21 in a compressor impeller chamber 72 formed in the compressor housing 7 in a state of being connected to the other end side of the rotating shaft 21. With these, the compressor 6 compresses intake air flowing through the intake flow passage.

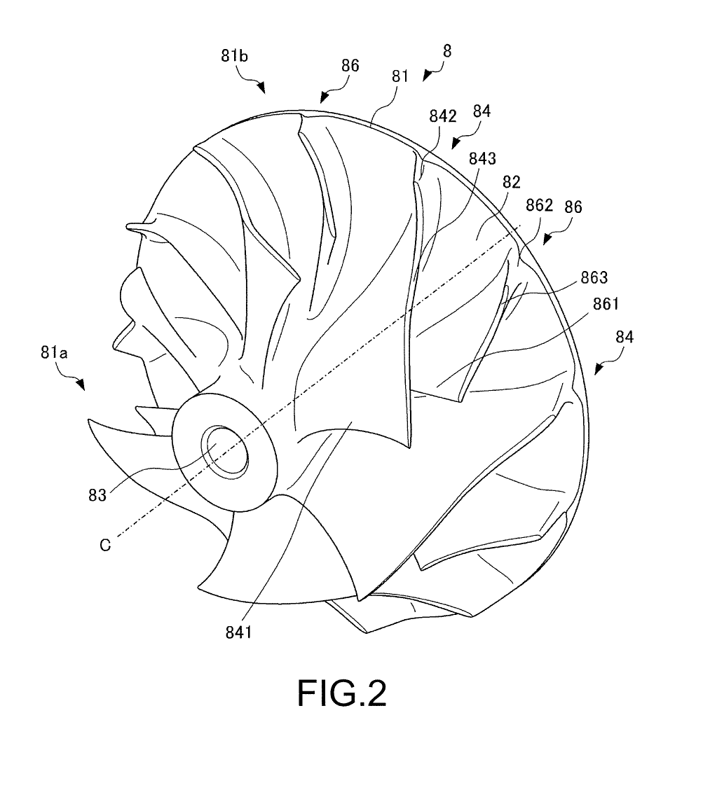

FIG. 2 is a perspective view of the compressor impeller 8. The compressor impeller 8 includes a conical wheel 81, and a plurality of plate-shaped main blades 84 and splitters 86 disposed on an outer peripheral surface of the wheel 81.

The wheel 81 has a hub surface 82 and a shaft mounting hole 83. The hub surface 82 extends smoothly outward in the radial direction from a distal end side 81a, which is in an axial direction parallel to an axis C, to a base end side 81b. The shaft mounting hole 83 penetrates the center of the wheel 81 from the base end side 81b to the distal end side 81a. The rotating shaft connected to the turbine impeller is connected to the wheel 81 by screwing a cap (not shown) while the rotating shaft is inserted into the shaft mounting hole 83. Thereby, the compressor impeller 8 and the turbine impeller are connected together via the rotating shaft.

The main blades 84 are disposed on the hub surface 82 of the wheel 81 at equal intervals along the circumferential direction. Each of the main blades 84 has a plate shape that extends in a predetermined angular distribution from a front edge portion 841 of the distal end side 81a, which is an inlet of the intake air, toward a rear edge portion 842 of the base end side 81b which is an outlet of the intake air, on the hub surface 82. A tip end edge 843 of the main blade 84 is formed along the surface shape of an opposing shroud 721, which will be described later (see FIG. 1), when the compressor impeller 8 is housed in the compressor impeller chamber 72.

The splitter 86 is disposed between two pieces of the main blades 84 that are adjacent to each other on the hub surface 82. Each of the splitters 86 has a plate shape that extends in a predetermined angular distribution from a front edge portion 861 of the distal end side 81a toward a rear edge portion 862 of the base end side 81b on the hub surface 82. A tip end edge 863 of the splitter 86 is formed along the surface shape of the shroud 721 (see FIG. 1) in the same manner as the tip end edge 843 of the main blade 84.

The compressor impeller 8 configured as described above rotates clockwise in FIG. 2 as the turbine impeller connected to it by the rotating shaft is blown by the exhaust air to rotate. When the compressor impeller 8 rotates in the state of being disposed in the compressor impeller chamber, the intake air flowing in from the distal end side 81a flows along the axial direction from the front edge portions 841 of the main blades 84 and the front edge portions 861 of the splitters 86 and flows between the main blades 84 and the splitters 86, and is discharged outward in the radial direction from the respective rear edge portions 842 and 862.

Reverting to FIG. 1, the compressor impeller chamber 72, an intake duct 73, a diffuser chamber 74, a main scroll flow passage 75, and an axial flow swirler 76 are formed in the compressor housing 7. The compressor impeller chamber 72 houses the compressor impeller 8. The intake duct 73 is connected to the intake flow passage (not shown) of the internal combustion engine and introduces the intake air flowing through the intake flow passage into the compressor impeller chamber 72. The diffuser chamber 74 decelerates the intake air discharged from the compressor impeller chamber 72. The main scroll flow passage 75 is for the intake air discharged from the diffuser chamber 74 to flow through. The axial flow swirler 76 generates a swirling flow with respect to the main flow of the intake air that flows into the compressor impeller chamber 72 via the intake duct 73.

In the compressor impeller chamber 72, the shroud 721 is formed to cover a side portion of the compressor impeller 8. The shroud 721 has a shroud surface in a shape that is along the tip end edge 843 from the front edge portion 841 to the rear edge portion 842 of the compressor impeller 8. More specifically, when the compressor impeller 8 rotates around the rotating shaft 21, the shape of the shroud surface is substantially equal to an envelope surface formed by the tip end edge 843 of the compressor impeller 8. The shroud 721 covers the tip end edge 843, which is the side portion of the compressor impeller 8, with this shroud surface. A side of the shroud 721 near the front edge portion 841 of the compressor impeller 8 becomes an intake inlet that has an inner diameter substantially equal to an outer diameter of the front edge portion 841. Moreover, a side of the shroud 721 near the rear edge portion 842 of the compressor impeller 8 becomes an annular intake outlet that has a width substantially equal to a height of the rear edge portion 842.

The intake duct 73 is formed with an axial flow passage 71 that extends to the intake inlet of the compressor impeller chamber 72 along the axial direction parallel to the axis C of the rotating shaft 21. The axial flow passage 71 is divided into a reduced diameter portion 711 and a straight portion 712. An inner diameter of the reduced diameter portion 711 gradually decreases from an upstream side toward the side of the intake inlet, which is a downstream side. The straight portion 712 has an inner diameter substantially equal to the intake inlet of the shroud 721. The axial flow passage 71 is connected to the intake flow passage of the internal combustion engine (not shown). The intake air of the internal combustion engine is accelerated in the process of flowing through the reduced diameter portion 711 and then introduced to the front edge portion 841 of the compressor impeller 8 disposed at the intake inlet.

The diffuser chamber 74 is annular and is formed to surround the intake outlet of the compressor impeller chamber 72. In the diffuser chamber 74, line blade rows are formed and erected at predetermined intervals along the circumferential direction of the compressor impeller 8. Accordingly, the intake air that has been discharged outward in the radial direction via the intake outlet from the rear edge portion 842 due to rotation of the compressor impeller 8 is decelerated in the process of flowing and spreading along the blade rows formed in the diffuser chamber 74 and is thereby compressed.

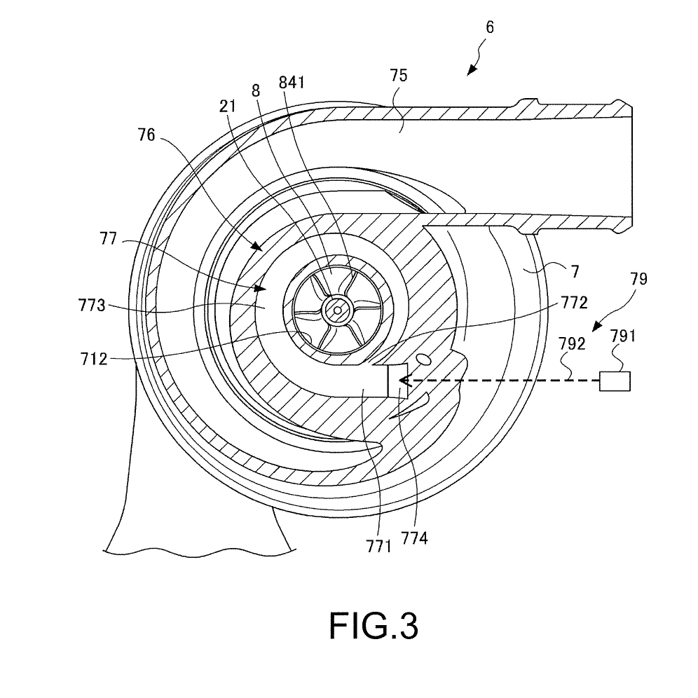

The main scroll flow passage 75 is annular and is formed to surround the diffuser chamber 74. A flow passage cross-sectional area of the main scroll flow passage 75 gradually increases along the same direction as the rotation direction of the compressor impeller 8 (see FIG. 3 which will be described later, for example). Thus, the intake air that has been discharged outward in the radial direction from the diffuser chamber 74 is further decelerated in the process of flowing through the main scroll flow passage 75 and then introduced to a combustion chamber of the internal combustion engine (not shown).

In the compressor housing 7 configured as described above, except for the axial flow swirler 76 which will be described later, the axial flow passage 71 of the intake duct 73, the shroud 721 of the compressor impeller chamber 72, the diffuser chamber 74, and the main scroll flow passage 75 constitute a part of the intake flow passage of the internal combustion engine.

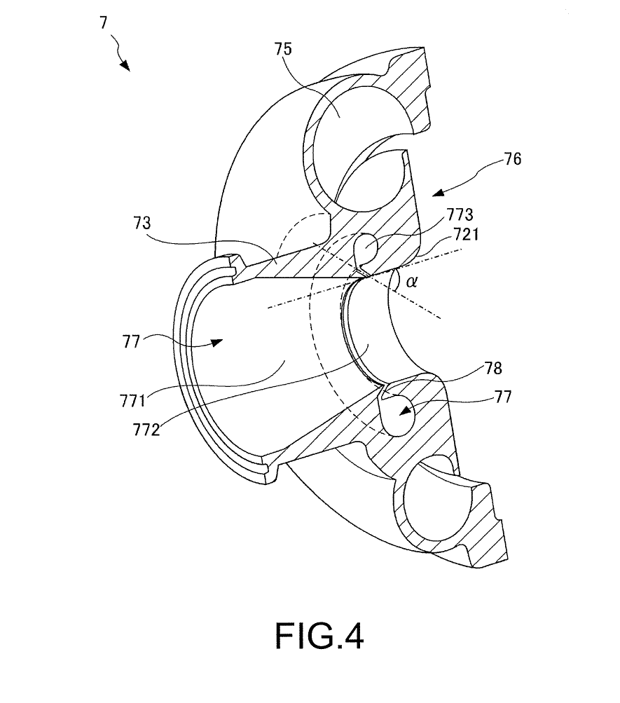

Next, the configuration of the axial flow swirler 76 is described with reference to FIG. 1 and FIG. 3 to FIG. 5. FIG. 3 is a cross-sectional view of the compressor housing 7 taken along the line III-III (see FIG. 1). FIG. 4 is a perspective cross-sectional view of the compressor housing 7 taken along a plane including the axis C.

The axial flow swirler 76 includes an annular swirling flow passage 77 accelerating a swirling gas along the circumferential direction of the compressor impeller 8, a swirling gas ejection passage 78 ejecting the swirling gas accelerated in the circumferential direction by the swirling flow passage 77 into the axial flow passage 71, and a swirling gas supply device 79 supplying the swirling gas to the swirling flow passage 77.

The swirling flow passage 77 includes a scroll flow passage 773 and a swirling gas introduction portion 774. The scroll flow passage 773 extends along the circumferential direction of the compressor impeller 8 from a base end portion 771 toward a distal end portion 772, and the swirling gas introduction portion 774 extends outward along a tangential direction from the base end portion 771. The scroll flow passage 773 communicates the base end portion 771 and the distal end portion 772, and is annular in a plan view as shown in FIG. 3. In addition, a flow passage cross-sectional area of the scroll flow passage 773 gradually decreases along the circumferential direction from the base end portion 771 toward the distal end portion 772, and more specifically, along the same direction as the rotation direction of the compressor impeller 8 (that is, clockwise in FIG. 3). Accordingly, when the swirling gas is supplied from the swirling gas supply device 79 to the swirling gas introduction portion 774 in the tangential direction of the scroll flow passage 773, the swirling gas is accelerated in the same direction as the rotation direction of the compressor impeller 8 in the process of flowing through the scroll flow passage 773 from the base end portion 771 to the distal end portion 772.

The swirling gas ejection passage 78 extends along the radial direction of the compressor impeller 8 and connects the inside of the scroll flow passage 773 with the straight portion 712 of the axial flow passage 71 formed inside the intake duct 73. The swirling gas ejection passage 78 is annular around the rotating shaft 21 and connects a radially inner portion inside the scroll flow passage 773 and the straight portion 712 over the entire circumference. Moreover, as shown in FIG. 1, the swirling gas ejection passage 78 is inclined with respect to the axial flow flowing through the straight portion 712. That is, an angle α (referred to as “axial inclination angle” hereinafter) (see FIG. 4) formed by an extending direction of the swirling gas ejection passage 78 and an inner peripheral surface of the straight portion 712 is an acute angle.

With the configuration as described above, the swirling gas supplied from the swirling gas supply device 79 to the swirling gas introduction portion 774 is ejected from the swirling gas ejection passage 78 toward the inside of the straight portion 712 while flowing through the scroll flow passage 773 from the base end portion 771 toward the distal end portion 772. At this time, because the swirling gas is accelerated in the same direction as the rotation direction of the compressor impeller 8 in the process of flowing through the scroll flow passage 773, the ejection flow of the swirling gas in the swirling gas ejection passage 78 has a velocity component in the same direction as the rotation direction. In addition, because the swirling gas ejection passage 78 is inclined with respect to the axial flow, the ejection flow of the swirling gas also has a velocity component in the same direction as the axial flow. By ejecting the swirling gas having such velocity components to the inside of the straight portion 712, a swirling flow is created in the axial flow that flows through the straight portion 712.

A reduction rate of the flow passage cross-sectional area of the scroll flow passage 773 is correlated to a magnitude of a rotation direction component of the ejection flow of the swirling gas in the swirling gas ejection passage 78. More specifically, as the reduction rate of the flow passage cross-sectional area of the scroll flow passage 773 is increased, a radial velocity of the swirling gas in the scroll flow passage 773 also increases. Therefore, the reduction rate of the flow passage cross-sectional area is adjusted so that the angle of the ejection flow in the swirling gas ejection passage 78 with respect to the axis C is, for example, 30 degrees or more. In addition, the above-described axial inclination angle α is set in a range of 15 degrees to 60 degrees, for example.

The swirling gas supply device 79 includes a gas acquisition port 791 and a gas supply passage 792. The gas acquisition port 791 is formed in a portion defined as a swirling gas supply source in the intake flow passage or the exhaust flow passage of the internal combustion engine. The gas supply passage 792 connects the gas acquisition port 791 and the swirling gas introduction portion 774. The swirling gas supply device 79 acquires the intake air or exhaust air in the supply source from the gas acquisition port 791 to serve as the swirling gas and supplies it to the swirling gas introduction portion 774 via the gas supply passage 792. Here, a flow rate regulating valve may be disposed in the gas supply passage 792 for adjusting the flow rate of the swirling gas that flows from the gas acquisition port 791 to the swirling gas introduction portion 774.

Here, in order to generate a sufficiently strong swirling flow in the axial flow passage 71, the gas acquisition port 791 needs to be disposed at least in a portion where a total pressure, which is a combination of a static pressure and a dynamic pressure, is higher than that inside the straight portion 712 where the ejection flow of the swirling gas is formed, so that the swirling gas flows in the scroll flow passage 773 from the base end portion 771 toward the distal end portion 772. Thus, the gas acquisition port 791 is disposed in a portion on the downstream side of the front edge portion 841 of the compressor impeller 8 in the entire flow passage that includes the intake flow passage and the exhaust flow passage of the internal combustion engine, that is, the portion where the total pressure is higher than that of the straight portion 712 in the axial flow passage 71, and as a result, the swirling gas introduction portion 774 and the portion with the high total pressure are connected via the gas supply passage 792.

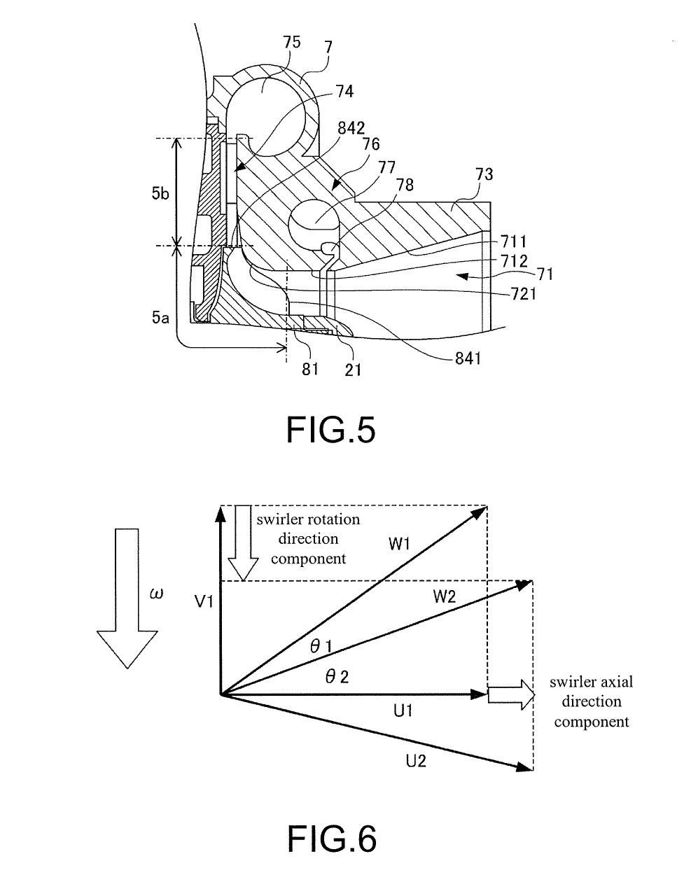

FIG. 5 is a cross-sectional view of the compressor housing 7. In the compressor housing 7, as described above, the shroud 721, the diffuser chamber 74, and the main scroll flow passage 75 respectively constitute a part of the intake flow passage on the downstream side of the front edge portion 841 of the compressor impeller 8, and the total pressure in each portion is higher than that inside the straight portion 712 during rotation of the compressor impeller 8. Therefore, the shroud 721 (that is, the section indicated by the arrow 5a in FIG. 5), the diffuser chamber 74 (that is, the section indicated by the arrow 5b in FIG. 5), and the main scroll flow passage 75 are all eligible as the position for disposing the gas acquisition port. Particularly, among the three portions, the sections indicated by the arrows 5a and 5b are close to the swirling gas introduction portion of the swirling flow passage 77 and therefore have the advantage of shortening the gas supply passage connecting these portions and consequently suppressing pressure drop in the flow passage.

FIG. 6 is a diagram schematically showing a variation of a velocity triangle at the front edge portion of the compressor impeller when the swirling flow is generated in the axial flow passage by the axial flow swirler described above.

First, in a case of not using the axial flow swirler, the axial flow is generated along the axial direction of the compressor impeller in the axial flow passage. That is, in this case, an absolute velocity vector U1 at the front edge portion is parallel to the axial direction. Moreover, in a case where the compressor impeller is rotating with the arrow ω as the rotation direction, a tangential velocity vector V1 at the front edge portion is in a direction opposite to the arrow ω and has a length proportional to the rotation velocity. Accordingly, a relative velocity vector W1 obtained by combining the two vectors U1 and V1 is inclined by an angle θ1 with respect to the axial direction.

Next, in a case of using the axial flow swirler, the swirling flow generated in the axial flow passage has a velocity component in the same direction as the rotation direction and a velocity component the same as the axial direction. Accordingly, in this case, an absolute velocity vector U2 at the front edge portion is inclined by the velocity component in the rotation direction (swirler rotation direction component) with respect to the absolute velocity vector U1 when the axial flow swirler is not used, and the absolute velocity vector U2 is longer than the absolute velocity vector U1 by the velocity component in the axial direction (swirler axial direction component). Accordingly, a relative velocity vector W2 obtained by combining the absolute velocity vector U2 and the tangential velocity vector V1 is inclined by an angle θ2, which is smaller than the aforementioned angle θ1, with respect to the axial direction. That is, the swirling flow generated by the axial flow swirler has an effect of reducing a relative inflow angle of the intake air at the front edge portion of the compressor impeller.

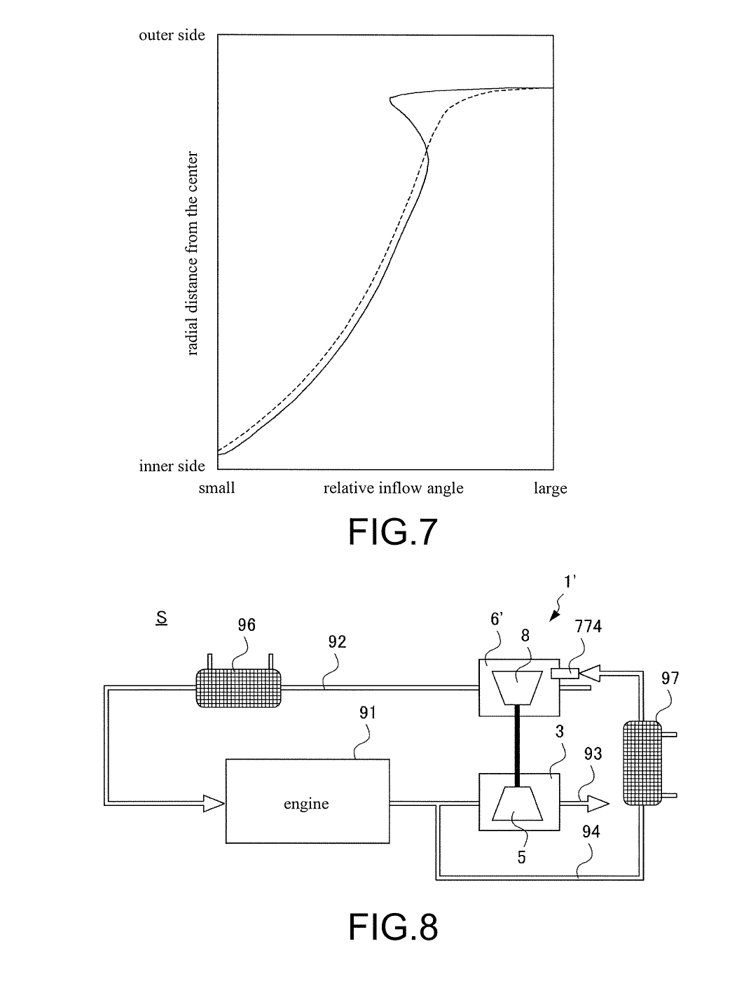

FIG. 7 is a diagram showing a radial distribution of the relative inflow angle at the front edge portion of the compressor impeller. In FIG. 7, the broken line indicates a distribution when the axial flow swirler is not used while the solid line indicates a distribution when the axial flow swirler is used.

As shown in FIG. 7, in the case of not using the axial flow swirler, that is, when the axial flow is generated along the axis in the axial flow passage, the relative inflow angle increases as it goes toward the radial outer side. The reason is that the rotation velocity increases toward the radial outer side. Further, in the case of using the axial flow swirler, the swirling flow is generated in the vicinity of the wall surface in the axial flow passage. In addition, as described above, this swirling flow has the effect of reducing the relative inflow angle and facilitating inflow of the intake air to the compressor impeller. Accordingly, as shown in FIG. 7, in the case of using the axial flow swirler, the relative inflow angle is reduced partially on the radial outer side, more specifically, in the vicinity of the wall surface of the axial flow passage. Therefore, by using the axial flow swirler, the inflow of the intake air to the compressor impeller in the vicinity of the wall surface of the axial flow passage is facilitated, so that the lower limit of the flow rate range of the compressor can be lowered.

According to the compressor 6 of the present embodiment, the following effects are achieved.

(1) According to the compressor 6 of the present embodiment, the intake air introduced to the scroll flow passage 773 from the swirling gas introduction portion 774 flows through the scroll flow passage 773 while being accelerated along the same direction as the rotation direction of the compressor impeller 8, and is ejected into the axial flow passage 71 of the intake duct 73 via the swirling gas ejection passage 78 and creates the swirling flow along the same direction as the rotation direction with respect to the axial flow that flows through the axial flow passage 71. By creating such a swirling flow in the intake air flowing to the front edge portion 841 of the compressor impeller 8, the relative inflow angle at the front edge portion 841 decreases and the intake air flows easily to the front edge portion 841. Thus, the lower limit of the flow rate range of the compressor 6 can be lowered. Moreover, in the compressor 6, the swirling gas introduction portion 774, which is the inlet of the scroll flow passage 773, is connected to the portion on the downstream side of the front edge portion 841 of the compressor impeller 8 in the entire flow passage that includes the intake flow passage and the exhaust flow passage of the internal combustion engine, that is, the portion where the total pressure is higher than that inside the straight portion 712, and the swirling flow is generated by using the swirling gas recirculated by the differential pressure. As a result, in the compressor 6, the swirling flow can be generated without using a part of the main flow that flows through the axial flow passage 71. Therefore, the generated swirling flow has a sufficient speed as compared with the conventional art. Furthermore, in the compressor 6, because the swirling flow is generated by recirculating the swirling gas, there is no need to dispose a device hindering the main flow in the axial flow passage 71. Thus, the pressure drop in the axial flow passage 71 is not worsened.

(2) In the compressor 6, the angle formed by the extending direction of the swirling gas ejection passage 78, which connects the inside of the scroll flow passage 773 and the inside of the axial flow passage 71, and the inner peripheral surface of the axial flow passage 71 is set to an acute angle, by which a swirling flow having an axial velocity component can be ejected from the swirling gas ejection passage 78. Thus, the lower limit of the flow rate range can be further lowered.

(3) In the compressor 6, the intake duct 73, the shroud 721, the swirling flow passage 77, the diffuser chamber 74, and the main scroll flow passage 75 are formed in the compressor housing 7, and the swirling gas introduction portion 774 of the swirling flow passage 77 is connected to any one of the shroud 721, the diffuser chamber 74, and the main scroll flow passage 75. Since the swirling gas can be recirculated in the compressor housing 7, the size of the entire compressor 6 can be reduced. Moreover, in the entire flow passage including the intake flow passage and the exhaust flow passage, the shroud 721, the diffuser chamber 74, and the main scroll flow passage 75 are in the vicinity of the compressor impeller 8, and the total pressure is higher than the other portions. Accordingly, by recirculating the swirling gas from such portions, a fast swirling flow can be generated.

### Second Embodiment

Next, the second embodiment of the invention is described with reference to the figures. FIG. 8 is a diagram showing the configuration of a supercharging system S of the internal combustion engine according to the present embodiment.

The supercharging system S includes an intake flow passage 92 that introduces intake air to a combustion chamber of an internal combustion engine 91, an exhaust flow passage 93 that introduces an exhaust air discharged from the combustion chamber of the internal combustion engine 91, a supercharger 1′ formed by combining a compressor 6′ disposed in the intake flow passage 92 and a turbine 3 disposed in the exhaust flow passage 93, an intercooler 96 that cools the intake air compressed by the compressor 6′ by using cooling water or outside air, an EGR flow passage 94 that recirculates a part of the exhaust air flowing through the exhaust flow passage 93 to the intake flow passage 92, and an EGR cooler 97 that cools the exhaust air flowing through the EGR flow passage 94 by using cooling water or outside air. The supercharger 1′ disposed in the supercharging system S differs from the supercharger 1 described in the first embodiment in the configuration of the compressor 6, more specifically the configuration of the swirling gas supply device, and the configurations of the other portions are the same.

The EGR flow passage 94 connects the portion of the exhaust flow passage 93, which is on the upstream side of the turbine impeller 5 of the turbine 3, with the swirling gas introduction portion 774 formed in the compressor 6′, so as to supply a part of the exhaust air flowing through the exhaust flow passage 93 as a swirling gas to the swirling gas introduction portion 774.

According to the supercharging system S of the present embodiment, the following effect (3) is achieved in addition to the aforementioned effects (1) to (2). (3) In the supercharging system S, the swirling gas introduction portion 774, which is the inlet of the swirling flow passage, is connected to the portion, which is on the downstream side of the front edge portion of the compressor impeller 8 in the entire flow passage including the intake flow passage 92 and the exhaust flow passage 93 and further on the upstream side of the turbine impeller 5 in the exhaust flow passage 93, by the EGR flow passage 94. That is, in the supercharging system S, the so-called high pressure external EGR gas is supplied to the swirling gas introduction portion 774 to generate a swirling flow. Thus, in addition to the effect of generating a high-speed swirling flow, it is also possible to achieve effects, such as reduction of NOx in the exhaust air and improvement of fuel efficiency, that are expected by recirculating a part of the exhaust air to the intake air.

Although the embodiments of the invention have been described above, the invention is not limited thereto. The configuration of the details may be modified where appropriate without departing from the scope of the spirit of the invention.

For example, in the embodiments described above, the flow passage cross-sectional area of the scroll flow passage 773 gradually decreases along the same direction as the rotation direction of the compressor impeller 8 from the base end portion 771 toward the distal end portion 772, so as to accelerate the swirling gas in the same direction as the rotation direction of the compressor impeller 8. Nevertheless, the invention is not limited thereto. The flow passage cross-sectional area of the scroll flow passage may gradually decrease along the direction opposite to the rotation direction of the compressor impeller from the base end portion toward the distal end portion to accelerate the swirling gas in the direction opposite to the rotation direction of the compressor impeller 8. In a state close to a stall, the main flow in the intake duct 73 in the vicinity of the shroud 721 tends to follow the rotation direction of the compressor impeller 8. Whereas, by configuring the scroll flow passage as described above and accelerating the swirling gas in the direction opposite to the rotation direction of the compressor impeller 8, a swirling flow in the direction opposite to the rotation direction of the compressor impeller 8 can be created to reduce the following, so that the lower limit of the flow rate range can be further lowered. However, in the case where the direction of the scroll flow passage is set opposite to the rotation direction of the compressor impeller 8 as described above, in order to reduce only the following and not to cause great influence on the entire main flow flowing through the intake duct 73, the flow rate of the intake air ejected from the swirling gas ejection passage 78 into the intake duct 73 is preferably set to about 10% or less of the flow rate of the entire intake air that flows into the compressor impeller 8.

For example, the embodiments described above illustrate that the compressor of the invention is applied to a supercharger that compresses intake air sucked in by the internal combustion engine, but the invention is not limited thereto. The compressor of the invention is applicable not only to the supercharger of the internal combustion engine but also to the so-called turbo machine, such as jet engine and pump, that performs conversion between fluid energy and mechanical energy by using an impeller.

What is claimed is:

1. A compressor compressing a fluid that flows through a fluid flow passage, the compressor comprising:
an impeller being rotatable around a rotating shaft;
a shroud covering a side portion of the impeller and constituting a part of the fluid flow passage;
a fluid duct being tubular and extending along an axial direction of the impeller and introducing the fluid to a front edge of the impeller;
a scroll flow passage being annular around the rotating shaft, wherein a flow passage cross-sectional area of the scroll flow passage gradually decreases along a circumferential direction of the impeller from a base end side where a fluid introduction portion is disposed toward a distal end side; and
a fluid ejection passage extending along a radial direction of the impeller and connecting an inside of the scroll flow passage and an inside of the fluid duct,
wherein the fluid introduction portion is connected to a portion on a downstream side of the front edge of the impeller in the fluid flow passage.

2. The compressor according to claim 1, wherein an angle formed by an extending direction of the fluid ejection passage and an inner peripheral surface in the fluid duct is an acute angle.

3. The compressor according to claim 1, wherein the flow passage cross-sectional area of the scroll flow passage gradually decreases along a direction the same as a rotation direction of the impeller from the base end side toward the distal end side.

4. The compressor according to claim 1, wherein the flow passage cross-sectional area of the scroll flow passage gradually decreases along a direction opposite to a rotation direction of the impeller from the base end side toward the distal end side.

5. The compressor according to claim 1, further comprising a compressor housing formed with the fluid duct, the shroud, the scroll flow passage, and a high pressure flow passage, which is a part of the fluid flow passage and through which a fluid discharged from a rear edge of the impeller flows,
wherein the fluid introduction portion is connected to the shroud or the high pressure flow passage in the compressor housing.

6. The compressor according to claim 5, wherein the fluid introduction portion is connected to the shroud.

7. The compressor according to claim 5, wherein a diffuser chamber is disposed in the compressor housing and the diffuser chamber is a part of the high pressure flow passage and decelerates the fluid discharged from the rear edge of the impeller in the radial direction, and
the fluid introduction portion is connected to the diffuser chamber.

8. The compressor according to claim 5, wherein a main scroll flow passage that is annular around the rotating shaft is disposed in the compressor housing, the main scroll flow passage is a part of the high pressure flow passage, and the fluid discharged from the rear edge of the impeller in the radial direction flows through the main scroll flow passage, and
the fluid introduction portion is connected to the main scroll flow passage.

9. A supercharging system of an internal combustion engine, the supercharging system comprising:
a compressor disposed in an intake flow passage of the internal combustion engine;
a turbine disposed in an exhaust flow passage of the internal combustion engine; and
a rotating shaft connecting an impeller of the compressor and an impeller of the turbine,
wherein the compressor is the compressor according to claim 1, and
the fluid introduction portion is connected to an upstream side of the impeller of the turbine in the exhaust flow passage.

10. The compressor according to claim 2, wherein the flow passage cross-sectional area of the scroll flow passage gradually decreases along a direction the same as a rotation direction of the impeller from the base end side toward the distal end side.

11. The compressor according to claim 2, wherein the flow passage cross-sectional area of the scroll flow passage gradually decreases along a direction opposite to a rotation direction of the impeller from the base end side toward the distal end side.

12. The compressor according to claim 2, further comprising a compressor housing formed with the fluid duct, the shroud, the scroll flow passage, and a high pressure flow passage, which is a part of the fluid flow passage and through which a fluid discharged from a rear edge of the impeller flows,
wherein the fluid introduction portion is connected to the shroud or the high pressure flow passage in the compressor housing.

13. The compressor according to claim 3, further comprising a compressor housing formed with the fluid duct, the shroud, the scroll flow passage, and a high pressure flow passage, which is a part of the fluid flow passage and through which a fluid discharged from a rear edge of the impeller flows,
wherein the fluid introduction portion is connected to the shroud or the high pressure flow passage in the compressor housing.

14. The compressor according to claim 4, further comprising a compressor housing formed with the fluid duct, the shroud, the scroll flow passage, and a high pressure flow passage, which is a part of the fluid flow passage and through which a fluid discharged from a rear edge of the impeller flows,
wherein the fluid introduction portion is connected to the shroud or the high pressure flow passage in the compressor housing.

15. The compressor according to claim 12, wherein the fluid introduction portion is connected to the shroud.

16. The compressor according to claim 13, wherein the fluid introduction portion is connected to the shroud.

17. The compressor according to claim 14, wherein the fluid introduction portion is connected to the shroud.

18. A supercharging system of an internal combustion engine, the supercharging system comprising:
a compressor disposed in an intake flow passage of the internal combustion engine;
a turbine disposed in an exhaust flow passage of the internal combustion engine; and
a rotating shaft connecting an impeller of the compressor and an impeller of the turbine,
wherein the compressor is the compressor according to claim 2, and the fluid introduction portion is connected to an upstream side of the impeller of the turbine in the exhaust flow passage.

19. A supercharging system of an internal combustion engine, the supercharging system comprising:
a compressor disposed in an intake flow passage of the internal combustion engine;
a turbine disposed in an exhaust flow passage of the internal combustion engine; and
a rotating shaft connecting an impeller of the compressor and an impeller of the turbine,
wherein the compressor is the compressor according to claim 3, and the fluid introduction portion is connected to an upstream side of the impeller of the turbine in the exhaust flow passage.

20. A supercharging system of an internal combustion engine, the supercharging system comprising:
a compressor disposed in an intake flow passage of the internal combustion engine;
a turbine disposed in an exhaust flow passage of the internal combustion engine; and
a rotating shaft connecting an impeller of the compressor and an impeller of the turbine,
wherein the compressor is the compressor according to claim 4, and
the fluid introduction portion is connected to an upstream side of the impeller of the turbine in the exhaust flow passage.
